(19) United States
(12) Patent Application Publication
(10) Pub. No.: US 2009/0008311 A1
(43) Pub. Date: Jan. 8, 2009

(54) Pure Oxygen Aeration System for Wastewater Treatment

(76) Inventor: Jai-Hun Lee, Gyeonggi-do (KR)

Correspondence Address: HOLME ROBERTS & OWEN LLP, 1700 LINCOLN STREET, SUITE 4100, DENVER, CO, 80203, US

(21) Appl. No.: 12/162,786

(22) PCT Filed: Feb. 1, 2007
(86) PCT No.: PCT/KR2007/000561

§ 371 Date: Jul. 30, 2008

(30) Foreign Application Priority Data
Feb. 2, 2006 (KR) 10-2006-0009947
Mar. 28, 2006 (KR) 10-2006-0027837

(51) Int. Cl. C02F 3/20

(52) U.S. Cl. 210/194; 210/192

(57) ABSTRACT

Disclosed is a pure oxygen aeration system for wastewater treatment, which biologically treats wastewater using microbes of activated sludge in an aeration tank. The pure oxygen aeration system comprises a pure oxygen supply device including a pure oxygen generator and at least one oxygen supply pipe extending from the pure oxygen generator and directed toward the internal space of the aeration tank, a high-speed jet injection device installed in the aeration tank, a mixed liquor circulation device for circulating and introducing the mixed liquor in which microbes of activated sludge, wastewater and pure oxygen are mixed, into the aeration tank through the high-speed jet injection device, and an oxygen suction pipe for sucking in the oxygen remaining in the headspace of the aeration tank and reintroducing the sucked oxygen into the water in the aeration tank. The present invention provides a pure oxygen aeration system for wastewater treatment which is economical, increases an oxygen utilization efficiency, secures easily the required land, saves the expense and can maintain an optimum level of dissolved oxygen and discharge smoothly and rapidly harmful gases.

### TECHNICAL FIELD

The present invention relates to a pure oxygen aeration system for wastewater treatment, and more particularly to a pure oxygen aeration system for wastewater treatment having an improved structure, which can facilitate the supply of pure oxygen to an aeration tank and the oxygen transfer in the aeration tank.

### BACKGROUND ART

A general wastewater treatment method comprises a pretreatment process for screening solids, such as suspended solids, sand and clay, a biological decomposition process for removing and decomposing organic matter and nutrients in wastewater using activated sludge, and a solid-liquid separation process for settling the activated sludge, in which microbes are increased in numbers during the biological decomposition process, decanting treated water, and returning the settled activated sludge to a biological decomposition process tank.

The biological decomposition process is the most important of the processes for wastewater treatment, and for a long time the representative biological decomposition process has been an activated sludge process.

The activated sludge process is a biological wastewater treatment method, in which pretreated wastewater and activated sludge returned from a settling tank are mixed in an aeration tank while air or oxygen, required for the respiration and growth of microbes, is introduced into the aeration tank, and thus microbes proliferate in the aeration tank and decompose organic matter or nutrients in the wastewater.

The typical aeration tank for a wastewater treatment process includes an air supply device for supplying air into the aeration tank, so that microbes in the activated sludge can respire. The air supply device generally comprises a diffuser installed in a lower part of an aeration tank, and a blower installed outside the aeration tank to supply atmospheric air into the aeration tank.

The above-described conventional air supply device in the aeration tank has disadvantageous effects in that the retention time of air in wastewater is short and the amount of supplied oxygen is insufficient for the respiration and growth of microbes of activated sludge because the atmospheric air supplied to the aeration tank contains only 21% oxygen and the air is introduced only through the diffuser.

In order to solve the above-described problems, a pure oxygen aeration system for wastewater treatment, which is capable of supplying gas containing 85 or higher percentage of oxygen to an aeration tank, has been developed.

FIG. 12 illustrates a conventional pure oxygen aeration system. The pure oxygen aeration system 101 for wastewater treatment according to the conventional art comprises an aeration tank 110 having a plurality of water basins 111a, 111b, and 111c, a pure oxygen supply device 120 for supplying oxygen to the aeration tank 110, and aeration mixers 130 installed in respective water basins 111a, 111b and 111c for dissolving the oxygen supplied to the aeration tank 110 into wastewater.

The aeration tank 110 is completely sealed, and has the water basins 111a, 111b and 111c divided by compartments 115 therein. An oxygen path 115a and a wastewater path 115b are provided at an upper portion and a lower portion of the compartment 115, respectively.

The first water basin 111a of the aeration tank 110 has a wastewater inlet hole 113 and an activated sludge inlet hole 114, so that pretreated wastewater and activated sludge, returned from a settling tank, are introduced into the first water basin 111a through the wastewater inlet hole 113 and the activated sludge inlet hole 114, respectively. Further, an oxygen pipe 116 is provided at the upper portion of the first water basin 111a, disposed above the surface of wastewater, so that oxygen can be supplied from the pure oxygen supply device 120 to the aeration tank.

The last water basin 111c of the aeration tank 110 has a treated water discharge hole 117 so that treated water passing through a biological decomposing treatment process in the aeration tank can be transferred to a settling tank. Further, a gas exhaust hole 119 is provided in an upper portion of the last water basin 11c, disposed above the surface of the water, so that harmful gas, such as carbon dioxide, can be exhausted through the gas exhaust hole 119.

The aeration mixer 130 comprises a driving motor 131 provided above the water basins 111a, 111b and 111c and having a rotating shaft 133 extended to lower sides of the water basins 111a, 111b and 111c, a surface aerator 135 coupled to the rotating shaft 133 and placed on water surfaces of the water basins 111a, 111b and 111c and an agitator 137 coupled to the rotating shaft 133 and placed in lower sides of the water basins 111a, 111b and 111c.

In this aeration mixer 130, the surface aerator 135 and the agitator 137 are rotated in response to a rotation of the driving motor 131 and the rotating shaft 133, the surface aerator 135 serves to splash up the wastewater near the surface to the headspace, and the agitator 137 serves to mix the wastewater under the water in the water basins 111a, 111b and 111c.

The biological wastewater treatment process using the above-described pure oxygen aeration system 101 for wastewater treatment will be described below.

The wastewater and activated sludge introduced into the first water basin 111a of the aeration tank 110 are transferred to the settling tank passing through the water basins 111a, 111b and 111c and the treated water discharge hole 117, and oxygen from the pure oxygen supply device 120 is supplied to the headspace in the first water basin 111a of the aeration tank 110.

On the other hand, the oxygen supplied to the headspace in the first water basin 111a comes into contact with droplets of wastewater splashed by a rotation of the surface aerator 135 and falls into the first water basin 111a along with the wastewater droplets, so that it is dissolved in wastewater. At this time, the oxygen dissolved in wastewater is mixed with wastewater and activated sludge by the agitator 137, so that oxygen transfer, which promotes the respiration and growth of microbes in the activated sludge in the first water basin 111a, can be accomplished.

The wastewater aerated in the first water basin 111a is transferred to the next water basin 111b through the wastewater path 115b, and oxygen which has not been yet in contact with wastewater is also transferred to the next water basin 111b through the oxygen path 115b.

Also, in the next water basin 111b, aeration such as a contact and mixing between oxygen and wastewater as described above is performed.

The wastewater reaching the last water basin 111c, as treated wastewater, is transferred to the settling tank through the treated water discharge hole 117, and gas moved to the headspace in the last water basin 111e and containing a low percentage of oxygen is exhausted into the air through the gas exhaust hole 119, as required.

In the manner as described above, oxygen is aerated in the aeration tank 110, microbes of activated sludge multiply, and thus the wastewater is biologically treated.

However, the above-described system is not cost-effective, and the efficiency of oxygen use is low, because oxygen is dissolved in the wastewater by splashing the wastewater into the oxygen gas to bring it into contact with oxygen.

Further, since the above-described system comprises a plurality of water basins and a plurality of surface aerators installed in respective water basins, and thus it occupies a large area of land, it incurs high land and facility installation costs.

Still further, since there is an upper limit to the length of the rotational shaft of the surface aerator, the depth of the aeration tank is limited (in general, 5 to 6 meters), and a large area of land is needed to install the facilities.

Yet further, even if the depth of the aeration tank is increased, there would still be problems in that an efficiency of oxygen use is lowered and it is difficult to maintain optimum levels of dissolved oxygen in the lower part of the aeration tank.

Yet further, since harmful gas such as carbon dioxide generated in the plurality of water basins is exhausted from only the last water basin in order to reduce the loss of oxygen, it is difficult to timely exhaust harmful gases, and thus microbes can be harmed by the toxicity of the harmful gases, and the pH is lowered.

### DISCLOSURE OF INVENTION

### Technical Problem

In order to solve the above problems, it is an object of the present invention to provide a pure oxygen aeration system for wastewater treatment, which has high efficiency of oxygen use and cost efficiency, incurs low land and facility installation costs, and can smoothly and rapidly exhaust harmful gases.

### Technical Solution

In order to achieve the above objects and advantageous effects, according to one aspect of the present invention, there is provided a pure oxygen aeration system for wastewater treatment, which biologically treats wastewater using microbes in activated sludge in an aeration tank, comprising a pure oxygen supply device including a pure oxygen generator for generating pure oxygen and at least one oxygen supply pipe extending from the pure oxygen generator to the aeration tank; a high-speed jet injection device installed in the aeration tank; a mixed liquor circulation device for circulating and introducing mixed liquor, in which microbes of activated sludge, wastewater and oxygen are mixed, into the high-speed jet injection device; and an oxygen suction pipe for sucking the oxygen remaining in the headspace of the aeration tank and reintroducing the oxygen into the water in the aeration tank.

The high-speed jet injection device preferably includes an inlet pipe through which mixed liquor from the mixed liquor circulation device is introduced, and a throat outlet having a diameter smaller than that of the inlet pipe. Preferably, the throat outlet is directed toward the lower part of the aeration tank.

The oxygen suction pipe has an oxygen suction hole disposed in the space above the surface of the water in the aeration tank, and has an oxygen discharge end disposed near the throat outlet of the high-speed jet injection device.

The high-speed jet injection device may be integrated with an expanding tube extending from the throat outlet, and the oxygen discharge end of the oxygen suction pipe is connected to the throat outlet of the high-speed jet injection device.

Further, it is more desirable that the pure oxygen aeration system for wastewater treatment may further comprise a guide pipe having a larger diameter than the expanding tube and surrounding concentrically the expanding tube and extended to the lower part of the aeration tank.

Alternatively, the high-speed jet injection device may further include a guide pipe concentrically surrounding the throat outlet with a diameter larger than the inlet pipe, and extended to the lower part of the aeration tank, and at least part of the oxygen suction pipe passes through the inlet pipe and the oxygen discharge end disposed near the throat outlet of the high-speed jet injection device.

The high-speed jet injection device may include a mixed liquor distribution manifold installed in the aeration tank through which mixed liquor is introduced from the mixed liquor circulation device, a plurality of inlet pipes branching off from the mixed liquor distribution manifold, and a plurality of high-speed jet nozzles having respective throat outlets, each having a diameter smaller than that of the inlet pipe.

At this time, it is preferred that the high-speed jet nozzle may be integrated with a tube having a diameter expanding from the throat outlet thereof.

On the other hand, the pure oxygen aeration system may further comprise an oxygen distributor including an oxygen distribution manifold installed in parallel above the mixed liquor distribution manifold and connected to at least one of lthe pure oxygen supply device and the oxygen suction pipe, and a plurality of oxygen supply pipes branching off from the oxygen distribution manifold and extending to the throat outlets of the high-speed jet nozzles.

Preferably, the oxygen branch pipe may pass through the inlet pipe of the high-speed jet nozzle.

The mixed liquor circulation device may comprise a mixed liquor circulation pipe connected to the high-speed jet injection device from an underwater position in the aeration tank, and a circulation pump for circulating the mixed liquor in the aeration tank to the high-speed jet injection device through the mixed liquor circulation pipe.

The high-speed jet injection device may be a submersible mixed liquor injection mixer installed underwater in the aeration tank, and the mixed liquor circulation device is a mixed liquor introduction mixer installed underwater in the aeration tank for introducing the mixed liquor into the rapid jet guide device.

The oxygen supply pipe of the pure oxygen supply device may extend to the lower part of the aeration tank and to the headspace of the aeration tank.

The mixed liquor circulation device may be implemented as a submersible pump installed in the lower part of the aeration tank and pumping the mixed liquor underwater in the aeration tank, and the inlet pipe of the high-speed jet injection device may be connected to a discharge port of the submersible pump.

The oxygen supply pipe of the pure oxygen supply device may be connected to the throat outlet of the high-speed jet injection device and to the headspace of the aeration tank.

The pure oxygen aeration system may further comprise an atmospheric air suction pipe connected to the oxygen suction pipe and having an air suction hole directed toward the outside of the aeration tank.

The pure oxygen aeration system may further comprise a bubble separator including a bubble separation tank provided outside the aeration tank, a first suction pipe connected between the headspace of the aeration tank and the bubble separation tank, and a second suction pipe connected between the bubble separation tank and the air suction pipe, or between the bubble separation tank and the oxygen suction pipe.

At this time, a blower may be installed at one side of the air suction pipe or the oxygen suction pipe to blow air toward the oxygen discharge end of the oxygen suction pipe.

The pure oxygen aeration system may further comprise a blower provided outside the aeration tank, in which the air suction pipe and the oxygen suction pipe are connected to a suction hole of the blower, and the oxygen supply pipe is connected to the pure oxygen generator and an outlet port of the blower and extends underwater at the lower part of the aeration tank.

The aeration tank may have a gas exhaust hole provided at an upper portion thereof, disposed above the surface of the water in the aeration tank, and directed toward the outside of the aeration tank.

The pure oxygen aeration system may further comprise at least one submersible mixer installed underwater in the aeration tank.

### ADVANTAGEOUS EFFECTS

As described above, the pure oxygen aeration system for wastewater treatment according to the present invention has high efficiency of oxygen use and cost effectiveness, incurs low land and facility installation costs, can maintain optimum dissolved oxygen levels, and can rapidly and smoothly exhaust harmful gases.

### BRIEF DESCRIPTION OF THE DRAWINGS

FIG. 1 is a cross-sectional view illustrating a pure oxygen aeration system for wastewater treatment according to the first embodiment of the present invention;

FIG. 2 is a cross-sectional view illustrating a pure oxygen aeration system for wastewater treatment according to another example of the first embodiment of the present invention;

FIG. 3 is a cross-sectional view illustrating a pure oxygen aeration system for wastewater treatment according to the second embodiment of the present invention;

FIG. 4 is a cross-sectional view illustrating a pure oxygen aeration system for wastewater treatment according to the third embodiment of the present invention;

FIG. 5 is a cross-sectional view illustrating a pure oxygen aeration system for wastewater treatment according to the fourth embodiment of the present invention;

FIG. 6 is a cross-sectional view illustrating a pure oxygen aeration system for wastewater treatment according to the fifth embodiment of the present invention;

FIG. 7 is a cross-sectional view illustrating a pure oxygen aeration system for wastewater treatment according to the sixth embodiment of the present invention;

FIG. 8 is a cross-sectional view illustrating a pure oxygen aeration system for wastewater treatment according to the seventh embodiment of the present invention;

FIG. 9 through FIG. 11 are sectional views taken along line A-A in FIG. 8 and showing a state where a high-speed jet injection device and an oxygen diffuser of the pure oxygen aeration system are installed; and

FIG. 12 is a cross-sectional view illustrating the conventional pure oxygen aeration system.

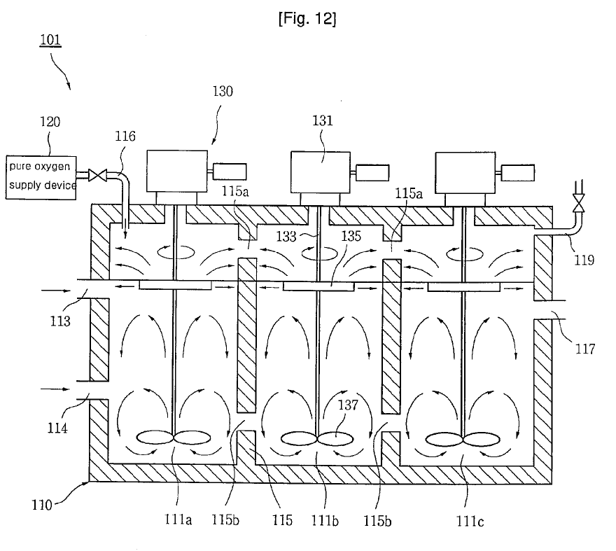

### BEST MODE FOR CARRYING OUT THE INVENTION

Hereinafter, the present invention will be described in detail with reference to the accompanying drawings.

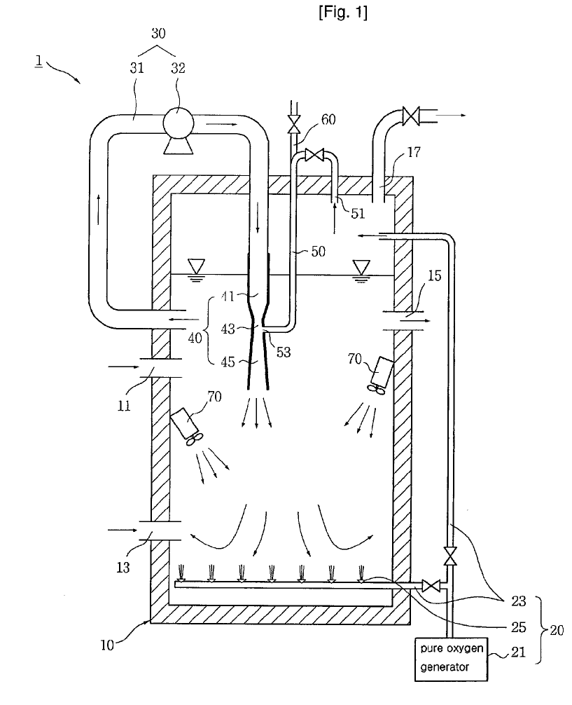

FIG. 1 is a cross-sectional view illustrating a pure oxygen aeration system for wastewater treatment according to a first embodiment of the present invention. As shown in FIG. 1, the pure oxygen aeration system 1 comprises an aeration tank 10 for providing space in which aeration is performed, a pure oxygen supply device 20 for supplying pure oxygen to the aeration tank 10, a mixed liquor circulation device 30 for circulating mixed liquor in the aeration tank 10, a high-speed jet injection device 40 for rapidly jetting the mixed liquor, circulated by the mixed liquor circulation device 30, to the lower part of the aeration tank 10, and an oxygen suction pipe 50 for sucking in the oxygen remaining in the headspace of the aeration tank 10 (hereinafter, referred to as “headspace oxygen”) and reinjecting the headspace oxygen into the middle of the water in the aeration tank 10.

The aeration tank 10 has a structure which is completely sealed, and has a wastewater inlet hole 11 and an activated sludge inlet hole 13 in one side thereof for allowing pre-treated wastewater and activated sludge returned from a settling tank (not shown) to be introduced thereinto. The aeration tank 10 further has a treated water discharge hole in the opposite side thereof so that biologically treated water can be discharged from the aeration tank 10 to the settling tank (not shown). The aeration tank 10 still further has a gas exhaust hole 17 in an upper portion thereof, above the surface of the water, for exhausting harmful gases such as carbon dioxide outside the aeration tank 10, and the gas exhaust hole 17 can be opened and closed.

The pure oxygen supply device 20 comprises a pure oxygen generator 21 and an oxygen pipe 23 extending from the pure oxygen generator 21 to the internal space of the aeration tank 10. The oxygen pipe 23 can be extended to the lower part of the aeration tank 10, underwater in the aeration tank 10, as well as to the space above the surface of the water in the aeration tank 10. The oxygen pipe 23 disposed in the water in the aeration tank 10 is provided with a plurality of membrane-type diffusers 25, so that pure oxygen can be supplied to the mixed liquor in the aeration tank 10 in the form of micro bubbles.

The pure oxygen supplied from the pure oxygen generator contains 60% or more oxygen, and more preferably contains 90% or more oxygen.

The mixed liquor circulation device 30 comprises a mixed liquor circulation pipe 31 extending from underwater in the aeration tank 10 to an upper portion of the aeration tank 10, and a circulation pump 32 for circulating the mixed liquor in the aeration tank 10 through the mixed liquor circulation pipe 31.

On the other hand, the high-speed jet injection device 40 used in this embodiment may be a Venturi nozzle type. The Venturi nozzle type high-speed jet injection device 40 comprises an inlet pipe 41 connected to the discharge section of the mixed liquor circulation pipe 31, a throat outlet 43 having a diameter smaller than that of the inlet pipe 41, and an expanding tube 45 having a diameter larger than that of the throat outlet 43. The high-speed jet injection device 40 is vertically installed so that the expanding tube 45 is directed toward the bottom of the aeration tank 10.

The high-speed jet injection device 40 discharges the mixed liquor toward the lower part of the aeration tank 10 at a high speed, which is realized by the reduced diameter at the throat outlet 43, and sucks in the headspace oxygen through an oxygen suction pipe 50 using pressure loss attributable to the throat outlet 43. For this reason, pure oxygen can be sufficiently dissolved in the mixed liquor, in which contaminants and microbes of activated sludge are mixed, and strong turbulent flow is generated due to the high speed of mixed liquor discharge, so that sufficient aeration can be achieved. Due to this aeration, pure oxygen turns into micro bubbles so that it can be efficiently dissolved in the mixed liquor in the aeration tank 10.

The Venturi-nozzle-type high-speed jet injection device 40 is commercially sold as a jet aerator, an ejector, or an injector. Accordingly, it is easy to obtain the Venturi-nozzle-type high-speed jet injection device 40 by purchasing it according to particular specifications. Further, the Venturi-nozzle-type high-speed jet injection device 40 can be designed by a user who wants to determine the diameters of the inlet pipe 41, the throat outlet 43, and the expanding tube 45, the slope of taper, and the connection point of the oxygen suction pipe.

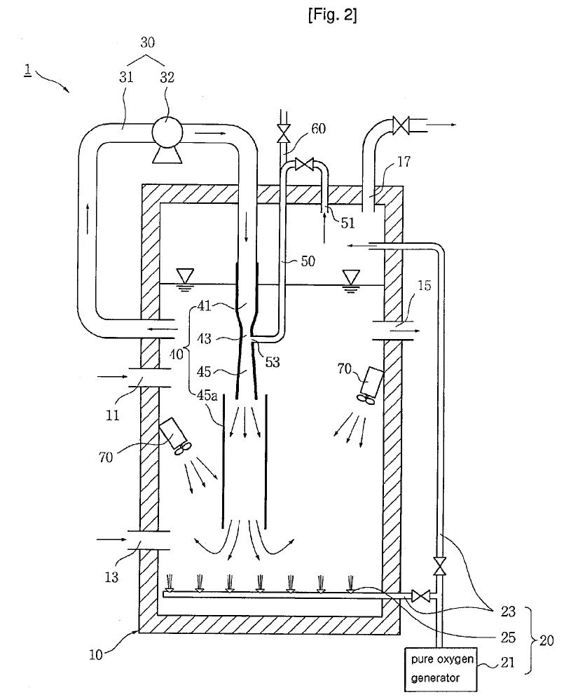

As shown in FIG. 2, the high-speed jet injection device 40 can further include a guide pipe 45a which concentrically surrounds the expanding tube 45 and extends to the lower part of the aeration tank 10. The guide pipe 45a extends the discharge area of the mixed liquor deep inside the water in the aeration tank 10.

The oxygen suction pipe 50 is installed in a manner such that an oxygen suction hole 51 is disposed above the surface of the water in the aeration tank 10 and an oxygen discharge end 53 is connected to the throat outlet of the high-speed jet injection device 40. The oxygen suction pipe 50 serves as a suction passage so that oxygen remaining in the headspace can be sucked into the high-speed jet injection device 40 when there is a pressure difference between the throat outlet 43 of the high-speed jet injection device 40 and the headspace of the aeration tank 10. The oxygen suction pipe 50 can be opened and closed by a valve.

The pure oxygen aeration system 1 for wastewater treatment according to the first embodiment of the present invention may preferably include an air suction pipe 60 for sucking in the atmospheric air and supplying the air into the aeration tank 10 in order to rapidly exhaust harmful gases, such as carbon dioxide.

The air suction pipe 60 is installed in a manner such that an air suction hole is directed toward the outside of the aeration tank 10, and can be connected to the oxygen suction pipe 50 and to the throat outlet 43 of the high-speed jet injection device 40, as shown in FIG. 1. At this time, the air suction pipe 60 may be opened and closed by a valve.

If an excessive amount of harmful gas is detected in the aeration tank 10, the valve of the oxygen suction pipe 50 is closed, but the gas exhaust hole 17 and the valve of the air suction pipe 60 are opened, so that a large amount of atmospheric air can be introduced into the aeration tank 10 in a short period. The harmful gas in the aeration tank 10 is then discharged outside the aeration tank 10 through the gas exhaust hole 17, and thus the harmful gas in the aeration tank 10 can be rapidly and easily removed. Since the harmful gas is removed in a short period by the inflow of atmospheric air, the level of dissolved oxygen in the mixed liquor in the aeration tank 10 can be maintained without any problem.

During this procedure, the concentrations of oxygen and the harmful gas such as carbon dioxide in the headspace of the aeration tank 10 can be easily monitored by sampling the gas using the oxygen suction pipe 50. Further, depending on the circumstances, additional equipment such as a gas remover for separating and removing harmful gas can be installed.

The pure oxygen aeration system 1 for wastewater treatment according to the first embodiment of the present invention may further include a submersible mixer 70 for maximizing aeration efficiency in order to mix microbes of activated sludge, pure oxygen and contaminants for facilitating efficient biological treatment.

The submersible mixer 70 is installed at a proper position underwater in the aeration tank 10 in order to facilitate mixing in the lower part of the aeration tank under the high-speed jet injection device 40.

Due to the submersible mixer 70, pure oxygen which is in the form of bubbles and not yet dissolved in the water in the aeration tank 10, is circulated again, and a large amount of the pure oxygen can be dissolved in the water in the aeration tank 10, and used for the respiration and growth of the microbes in the activated sludge.

The wastewater treatment procedure using the pure oxygen aeration system 1 according to the embodiment of the present invention will be described below.

Wastewater and activated sludge introduced into the aeration tank 10 are mixed with pure oxygen by aeration mechanism in the aeration tank 10, and the wastewater is then biologically treated, and the treated water is transferred to the settling tank (not shown) through the treated water discharge hole 15 in the same amount as that of wastewater introduced into the aeration tank 10.

During this procedure, pure oxygen needed for the respiration of microbes of activated sludge is supplied to the headspace of the aeration tank 10 or underwater in the aeration tank 10. Pure oxygen can be selectively supplied to only any one of the headspace of the aeration tank 10 through the oxygen pipe 23 and the underwater through the diffusers 25 installed in the lower part of the aeration tank 10, or it can be simultaneously supplied by both means, if necessary.

Some of the pure oxygen supplied to the lower part of the aeration tank 10 is dissolved in the water in the aeration tank 10 and is used for the respiration of the microbes of activated sludge, but substantial amount of the pure oxygen travels to and remains in the headspace of the aeration tank 10.

The headspace oxygen is sucked through the oxygen suction pipe 50 by the pressure loss generated at the throat outlet 43 of the high-speed jet injection device 40, and is returned underwater in the aeration tank 10 along with mixed liquor. Below, this procedure will be described in more detail.

The mixed liquor in the aeration tank 10 is circulated through the mixed liquor circulation pipe 31 and the high-speed jet injection device 40 by the operation of the circulation pump 32. The mixed liquor passing through the high-speed jet injection device 40 gains very high speed while passing through the throat outlet 43 because the sectional area thereof is reduced, and is discharged toward the lower part of the aeration tank 10 at very high speed.

At this time, a great deal of pressure loss is caused at the throat outlet 43, creating a pressure difference between the headspace of the aeration tank 10 and the throat outlet 43, and thus headspace oxygen is rapidly sucked back into the water through the oxygen suction pipe 50.

The headspace oxygen sucked through the oxygen suction pipe 50 is mixed with the mixed liquor in the high-speed jet injection device 40 and is jetted down toward the lower part of the aeration tank 10, and so pure oxygen can be sufficiently dissolved in the mixed liquor of contaminants and microbes of activated sludge. Further, strong turbulent flow is formed by the high speed of the discharged mixed liquor so that sufficient aeration is achieved underwater in the aeration tank 10. The pure oxygen is turned into micro bubbles by the shear force of the turbulence, so that it can be efficiently dissolved underwater in the aeration tank 10 and used for the respiration of microbes.

The discharge force of the mixed liquor, which is mixed with pure oxygen, can be adjusted according to the pumping pressure of the circulation pump 32 and the design of the high-speed jet injection device 40. As the discharge force of the mixed liquor increases, the aeration can sufficiently reach the lower part of the aeration tank 10.

Accordingly, even if the effective water depth of the aeration tank is increased, sufficient aeration can be achieved by increasing the discharge force of the high-speed jet injection device 40, so that optimum dissolved oxygen can be maintained even in the lower part of the aeration tank 10. Further, the treatment capacity can be increased by increasing the effective water depth, too. Accordingly, the area of land required to install the aeration tank 10 can be reduced.

As described above, the submersible mixer 70 can be optionally installed in the aeration tank 10 in order to increase the efficiency of mixing of activated sludge, pure oxygen and wastewater. The submersible mixer 70 repeatedly circulates pure oxygen in the form of bubbles, which are not yet dissolved in water, in the aeration tank 10, thereby increasing the dissolution rate of pure oxygen, so that microbes of activated sludge can use the pure oxygen for the respiration and growth thereof.

In case where the submersible mixer 70 is installed under the high-speed jet injection device 40, the mixing zone in the aeration tank 10 is extended to the lower part of the aeration tank 10, so that the effective depth and treatment capacity of the aeration tank 10 are maximized, dissolved oxygen is maintained at an optimum level, and the area of land required for installation of the aeration tank 10 can be minimized.

Further, if the concentration of harmful gas, such as carbon dioxide, is detected to be excessive due to the respiration of microbes of activated sludge in the aeration tank 10, the valve for the gas exhaust hole 17 is opened and thus harmful gas can be exhausted to an outside.

As described above, in a case where the system includes the air suction pipe 60, if the valves for the air suction pipe 60 and the gas exhaust hole 17 are opened in the state where the valve for the oxygen suction pipe 50 is closed, due to the rapid pressure loss occurring at the throat outlet 43 of high-speed jet injection device 40, atmospheric air is rapidly introduced into the aeration tank 10 through the air suction pipe 60, and thus harmful gas is easily and rapidly exhausted to the gas exhaust hole 17. Since the exhaust of harmful gas is conducted in a short period, there is no adverse effect on the maintenance of dissolved oxygen in the water in the aeration tank 10.

Since most of the pure oxygen supplied to the aeration tank 10 can be dissolved underwater in the aeration tank 10 by the strong aeration of the high-speed jet injection device 40, the headspace in the aeration tank 10 is smaller by far than that of other conventional methods, and contains just a small amount of oxygen.

Accordingly, although the gas exhaust hole 17 is opened, since only a small amount of oxygen is exhausted along with the harmful gas, the oxygen loss caused by this operation is minimal. For this reason, the efficiency of oxygen utilization is not reduced.

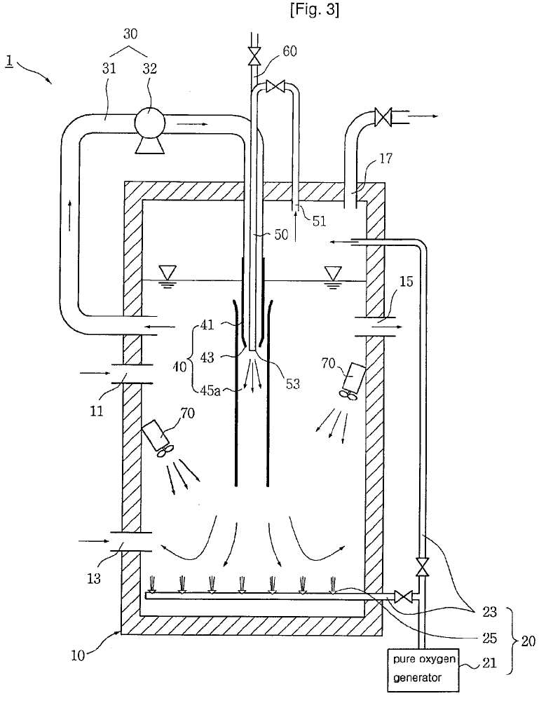

FIG. 3 illustrates a pure oxygen aeration system for wastewater treatment according to the second embodiment of the present invention. As shown in FIG. 3, the pure oxygen aeration system 1 according to the second embodiment has the same construction, operation and advantageous effects as those of the pure oxygen aeration system according to the first embodiment of the present invention, except for the structure of the high-speed jet injection device 40 and the connection structure of the oxygen suction pipe 50. Accordingly, only the structure of the high-speed jet injection device 40 and the connection structure of the oxygen suction pipe 50 of the pure oxygen aeration system according to the second embodiment will be described.

The high-speed jet injection device 40 of the pure oxygen aeration system 1 for wastewater treatment according to the second embodiment of the present invention comprises an inlet pipe 41 for discharging mixed liquor transferred from a mixed liquor circulation pipe 31 at high speed, and a guide pipe 45a for guiding the mixed liquor, discharged from the inlet pipe 41, to the lower part of the aeration tank 10. Further, an oxygen pipe 50 is disposed in the inlet pipe 41. That is, the high-speed jet injection device 40 is a two-phase nozzle type.

The inlet pipe 41 is connected to the mixed liquor circulation pipe 31, and has a throat outlet 43 which is directed toward the lower part of the aeration tank 10 and has a diameter smaller than that of the inlet pipe 41. The guide pipe 45a concentrically surrounds the throat outlet 43 of the inlet pipe 41 and extends to the lower part of the aeration tank 10.

On the other hand, the oxygen suction pipe 50 has an oxygen suction hole 51 disposed above the surface of the water in the aeration tank 10, passes through a portion of the inlet pipe 41, and has an oxygen discharge end 53 disposed at the discharge end area of the inlet pipe 41. Here, it is preferred that the oxygen suction pipe 50 is disposed in the center portion of the inlet pipe 41 to maximize the smoothness of circulation of the mixed liquor and the suction of pure oxygen.

Here, the oxygen suction pipe 50 can be opened and closed by manipulating a valve, and an air suction pipe 60 can be opened/closed and connected to one area of the oxygen suction pipe 50, as done for the first embodiment described above.

Similar to the pure oxygen aeration system according to the first embodiment of the present invention, in the pure oxygen aeration system 1 having the high-speed jet injection device 40 and the air suction pipe 50 as described above, according to the second embodiment of the present invention, the mixed liquor is discharged at high speed into the aeration tank 10 using a high discharge speed caused by the reduction in the diameter of the throat outlet 43 of the inlet pipe 41.

Further, the oxygen remained above the surface of the water is sucked in through the oxygen suction pipe 50 due to the great pressure loss occurring at the throat outlet 43, and is discharged at high speed along with the mixed liquor. With this, pure oxygen can be sufficiently dissolved in the mixed liquor of contaminants and microbes of activated sludge.

On the other hand, the mixed liquor blended with pure oxygen, discharged at high speed through the inlet pipe 41 and the oxygen suction pipe 50, maintains a strong discharge force and thus is supplied deep inside the water in the aeration tank 10 along the guide pipe 45a. Accordingly, the mixing efficiency is increased and the efficiency of oxygen utilization is enhanced, since the retention time of pure oxygen in the aeration tank 10 is increased.

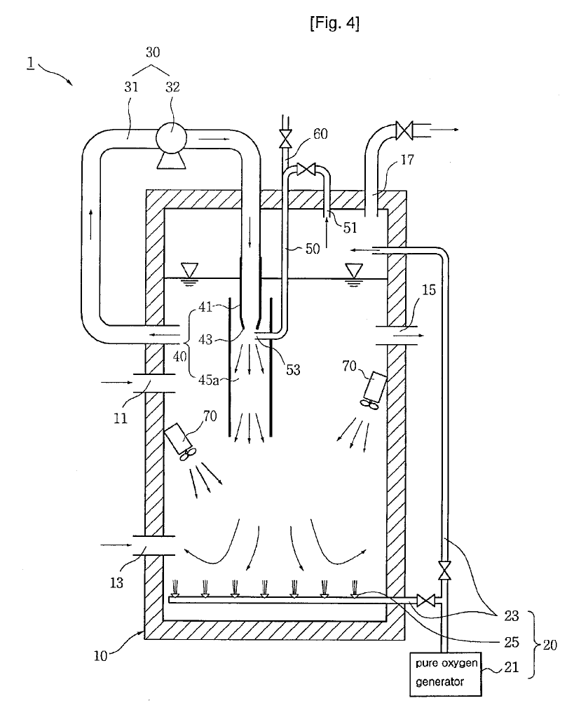

FIG. 4 is a cross-sectional view illustrating a pure oxygen aeration system for wastewater treatment according to the third embodiment of the present invention. As shown in FIG. 4, the pure oxygen aeration system 1 according to the present embodiment is almost the same as the pure oxygen aeration system 1 according to the second embodiment of the present invention in the construction, operation, and advanageous effects, except for the connection structure of the oxygen pipe 50. Accordingly, the pure oxygen aeration system according to the third embodiment of the present invention will be described herein only with reference to the connection structure of the oxygen suction pipe 50.

In the pure oxygen aeration system 1 for wastewater treatment according to the third embodiment of the present invention, the oxygen suction pipe 50 has an oxygen suction hole 51 disposed in the space above the surface of the water in the aeration tank 10, and has an oxygen discharge end 53 disposed near the discharge end area of the throat outlet 43 of the inlet pipe 41.

The oxygen suction pipe 50 can also be opened and closed by the manipulation of valves, and the air suction pipe 60 can be connected to an area of the oxygen suction pipe 50 with opening and closing mechanism, like the first embodiment and the second embodiment.

The pure oxygen aeration system having the above described connection structure of the oxygen suction pipe 50, according to the third embodiment, can sufficiently dissolve pure oxygen in the mixed liquor, in which contaminants and microbes are mixed, using the high discharge speed of the mixed liquor occurring near the throat outlet 43 of the inlet pipe 41 and the suction of the headspace oxygen in the aeration tank 10.

The mixed liquor blended with pure oxygen can be supplied deeply enough to the lower part of the aeration tank 10 via the guide pipe 45a, thereby mixing the water in the aeration tank 10. For this reason, the mixing efficiency of the mixed liquor is increased, and the efficiency of oxygen utilization is enhanced due to the increased retention time of pure oxygen in the aeration tank 10.

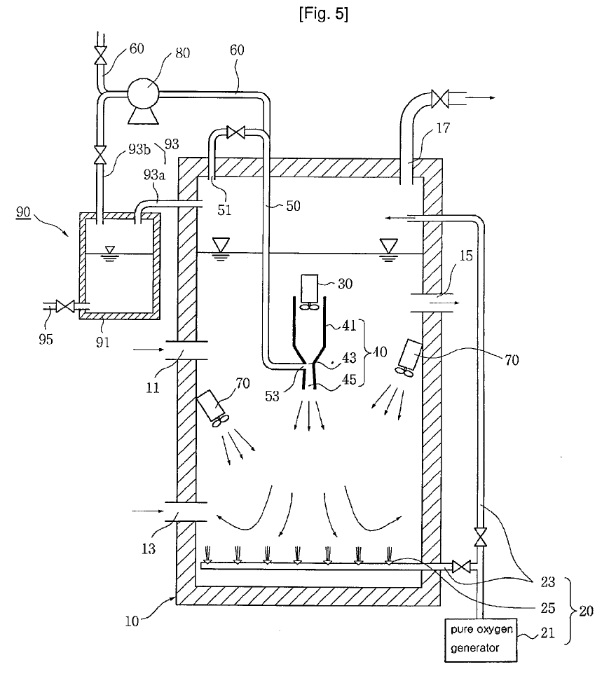

FIG. 5 is a cross-sectional view illustrating the pure oxygen aeration system for wastewater treatment according to the fourth embodiment of the present invention. As shown in FIG. 5, the pure oxygen aeration system 1 according to the present embodiment of the present invention is different from the pure oxygen aeration system 1 according to the above-described embodiments of the present invention with respect to the high-speed jet injection device 40, the mixed liquor circulation device 30, the procedure for reintroducing the headspace oxygen into the aeration tank 10, and the method of drawing atmospheric air to exhaust harmful gas. The pure oxygen aeration system according to the fourth embodiment of the present invention further includes a foam separator 90 for removing bubbles generated in the headspace of the aeration tank 10.

Only the high-speed jet injection device 40, the mixed liquor circulation device 30, the structure for reusing the headspace oxygen and supplying atmospheric air to the aeration tank for removing harmful gas, and the foam separator 90 will be described below for this embodiment.

The high-speed jet injection device 40 provided in this embodiment is installed upward in the water in the aeration tank 10, and has a structure in which an inlet pipe 41 having a relatively large diameter, through which mixed liquor is introduced, a throat outlet 43, disposed to be directed toward the lower part of the aeration tank 10 and having a diameter smaller than that of the inlet pipe 41, and an expanding tube 45 which is gradually enlarged in diameter from the throat outlet 43, are integrated as a single body.

The mixed liquor circulation device 30 is installed underwater near the inlet pipe 41 of the high-speed jet injection device 40, and is implemented as a mixed liquor injection mixer 30 for introducing mixed liquor into the inlet pipe 41 of the high-speed jet injection device 40.

As the mixed liquor injection mixer 30 is driven, mixed liquor in the upper portion of the water in the aeration tank 10 is introduced into the inlet pipe 41 of the high-speed jet injection device 40, and the mixed liquor in the inlet pipe 41 gains flow speed at the throat outlet 43, having a relatively smaller diameter, and the mixed liquor is jetted toward the lower part of the aeration tank 10 through the expanding tube 45. At this time, a substantial amount of pressure loss occurrs at the throat outlet 43, as in the case of previous embodiments.

Here, if the sectional area of the throat outlet 43 is excessively reduced, the mixed liquor injection mixer 30 can be overloaded, so that it may fail or be damaged. Accordingly, it should preferably be designed in a manner such that the expanding tube 45 is gradually enlarged and has a gentle slope. In this case, pressure loss at the throat outlet 43 can be insufficient, but this problem can be solved by a blower 80, which will be described below.

The oxygen suction hole 51 of the oxygen suction pipe 50 is disposed in the space above the surface of the water in the aeration tank 10, and the oxygen discharge end 53 of the oxygen suction pipe 50 is connected to the throat outlet 43 of the high-speed jet injection device 40. The oxygen suction pipe 50 is installed in a manner such that it can be opened and closed by manipulating a valve, and the air suction pipe 60 is also connected to the oxygen suction pipe 50 in a manner such that it can be opened and closed.

In this instance, a blower 80, which can blow atmospheric air or the headspace oxygen to the throat outlet 43 of the high-speed jet injection device 40, can be installed at one end of the air suction pipe 60. As described above, the blower 80 is provided in the case in which pure oxygen cannot be smoothly sucked in by the high-speed jet injection device. The foam separator 90 comprises a foam separation tank 91 serving as a space for receiving foams created in the headspace of the aeration tank 10, and a suction pipe 93 which sucks foams and the headspace oxygen of the aeration tank 10, transfers them to the foam separation tank 91 and circulates oxygen from which foams are separated.

The foam separation tank 91 is disposed outside the aeration tank 10, and a foam remover which sprays a foam removal agent such as an antifoaming agent is preferably installed in the foam separation tank 91. Liquid, from which the foams have been removed, is transferred to the aeration tank 10 through a drain pipe 95, or is returned to a wastewater tank (not shown), disposed on the upstream side of the aeration tank 10.

The suction pipe 93 comprises a first suction pipe 93a connected between the space disposed above the surface of the water in the aeration tank 10 and the space above the liquid in the bubble separation tank 91, and a second suction pipe 93b, connected to the space above the liquid in the bubble separation tank 91 and directed toward the suction hole (not shown) of the blower 80. The second suction pipe 93b can be connected to the air suction pipe 60 connected to the blower 80 in a state in which the suction pipe 93b can be opened and closed by a valve.

In the pure oxygen aeration system 1 for wastewater treatment according to the fourth embodiment of the present invention comprising the above structure, the mixed liquor causes strong turbulent flow and is introduced into the high-speed jet injection device 40 by driving the mixed liquor injection mixer 30, and, at the same time, the mixed liquor is discharged and jetted down toward the lower part of the aeration tank 10 through the throat outlet 43.

At this time, due to the great pressure loss occurring at the throat outlet 43, oxygen remaining above the surface of the water in the aeration tank 10 is rapidly sucked through the oxygen suction pipe 50.

The oxygen sucked into the oxygen suction pipe 50 is blended with the mixed liquor at the throat outlet of the high-speed jet injection device 40, and is jetted down toward the lower part of the aeration tank 10 at high speed, and thus oxygen can be sufficiently dissolved into the mixed liquor of contaminants and microbes in the activated sludge. Further, a highly turbulent flow is caused by the high-speed discharge of mixed liquor, and thus sufficient aeration is conducted in the water in the aeration tank 10. Pure oxygen is shredded into micro bubbles by the strong shear caused by this turbulence and thus is efficiently dissolved into water in the aeration tank 10, and so it can be used for the respiration of microbes. At this time, driving the blower 80 can cause the pure oxygen to be more rapidly introduced into the high-speed jet injection device 40.

For this reason, the underwater mixing rate of the aeration tank 10 is increased and the retention time of pure oxygen in the aeration tank 10 is increased, so that the efficiency of oxygen utilization is increased.

In the procedure in which the headspace oxygen from the aeration tank 10 is sucked through the oxygen suction pipe 50, foams, which are created in the aeration tank 10, due to the suction operation of the first suction pipe 93a, are transferred to the foam separation tank 91 along with the headspace oxygen. The remaining oxygen, from which foams are removed in the foam separation tank 91, is sucked into the high-speed jet injection device 40 through the second suction pipe 93b and the oxygen suction pipe 50, and is then reintroduced into the water in the aeration tank 10. As described above, the liquid in the foam separation tank 91 is either reintroduced into the aeration tank 10 through the drain pipe 95, or is returned to the wastewater tank (not shown) disposed on the upstream side of the aeration tank 10.

If the concentration of harmful gas in the aeration tank 10 is determined to be excessive, the gas exhaust hole 17 of the aeration tank 10 is opened and the harmful gas is exhausted. In the state where the valves of the oxygen suction pipe 50 and the second suction pipe 93b are closed, if the valves of the gas exhaust hole 17 and the air suction pipe 60 are opened, atmospheric air is rapidly sucked into the aeration tank 10 through the air suction pipe 60 due to the great pressure loss occurring at the throat outlet 43 of the high-speed jet injection device 40, and the harmful gas is easily and rapidly exhausted through the gas exhaust hole 17. At this time, driving the blower 80 can cause the atmospheric air to be more rapidly introduced into the aeration tank 10.

As described above, the pure oxygen aeration system 1 for wastewater treatment according to the fourth embodiment of the present invention can enhance the efficiency of oxygen utilization and the advantageous effects as achieved by the pure oxygen system according to other embodiments, and can, at the same time, effectively remove foams created in the aeration tank 10.

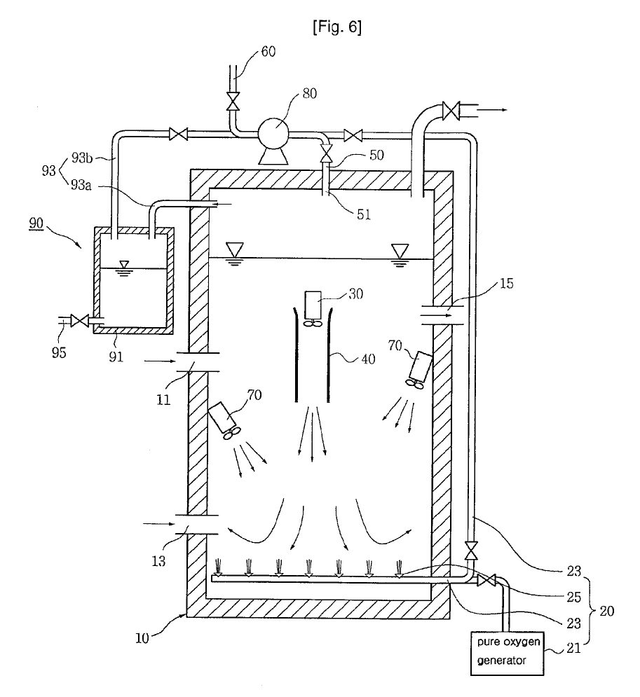

FIG. 6 is a cross-sectional view illustrating a pure oxygen aeration system for wastewater treatment according to the fifth embodiment of the present invention. As shown in FIG. 6, the pure oxygen aeration system 1 according to the fifth embodiment of the present invention is very similar to the pure oxygen aeration system 1 according to the fourth embodiment of the present invention, except for the method of supplying pure oxygen, the structure of the high-speed jet injection device 40, and the method of reintroducing the headspace oxygen in the aeration tank 10 and introducing atmospheric air into the aeration tank 10 for the removal of harmful gas.

Accordingly, in order to explain the pure oxygen aeration system according to the fifth embodiment of the present invention, only the pure oxygen supply method, the structure of the high-speed jet injection device 40, the structure for reintroducing the headspace oxygen, and the method of introducing atmospheric air for removing harmful gas will be described.

The pure oxygen supply device 20 comprises a pure oxygen generator 21 installed outside the aeration tank 10, a diffuser 25 for supplying pure oxygen transferred from the pure oxygen generator 21 into water in the aeration tank 10, and an oxygen supply pipe 23 connected between a blower 80 (described below) and the diffuser 25.

And, a high-speed jet injection device 40 in cylindrical shape is installed vertically in the water in the aeration tank 10. At the upper inlet area of the high-speed jet injection device 40, a mixed liquor injection mixer 30 is disposed to facilitate the injection of the mixed liquor from the upper area of the aeration tank 10 into the high-speed jet injection device 40.

Due to an operation of the mixed liquor injection mixer 30, the mixed liquor in the upper portion of the aeration tank 10 is strongly jetted down toward the lower part of the aeration tank 10 through the expanding tube 45. With this, strong turbulent flow is created in the lower part of the aeration tank 10, so that contaminants and microbes in the activated sludge can be efficiently mixed.

On the other hand, the oxygen suction pipe 50 is connected to a suction port (not shown) of the blower 80 in the state where the oxygen suction hole 51 is disposed above the surface of the water in the aeration tank 10. Further, the oxygen supply pipe 23 of the pure oxygen supply device 20 is connected to a discharge area of the blower 80. The oxygen suction pipe 50 and the oxygen supply pipe 23 can be opened and closed by a valve.

Further, the air suction pipe 60 for sucking atmospheric air is connected to a suction port area (not shown) of the blower 80, as described in the fourth embodiment of the present invention, and the second suction pipe 93b extending from the bubble separation tank 91 is connected to the air suction pipe 60 connected to the blower 80 in a manner such that it can be opened and closed by a valve.

In the pure oxygen aeration system 1 according to the fifth embodiment of the present invention, due to the driving of the mixed liquor injection mixer 30, the mixed liquor in the aeration tank 10 is introduced into the high-speed jet injection device 40, causing strong turbulent flow, and is strongly discharged and jetted down toward the lower part of the aeration tank 10 through the throat outlet 43 of the high-speed jet injection device 40. For this reason, aeration of the water in the aeration tank 10 is enhanced, and the efficiency of use of pure oxygen is increased. Like the fourth embodiment of the present invention, foams created in the aeration tank 10 are effectively removed by the foam separator 90.

Oxygen remained above the surface of the water and sucked into the oxygen suction pipe 50 is supplied to the water in the aeration tank 10 through the diffusers 25 installed in the lower part of the aeration tank 10 via the oxygen supply pipe 23, with the aid of the blowing operation of the blower 80.

The oxygen remained above the surface of the water is turned into micro bubbles in the diffusers 25, and is introduced into the water in the aeration tank 10, and thus it is effectively dissolved in the water in the aeration tank 10 by underwater aeration, conducted by high-speed jet injection device 40 and the mixed liquor injection mixer 30. For this reason, the efficiency of oxygen utilization is increased.

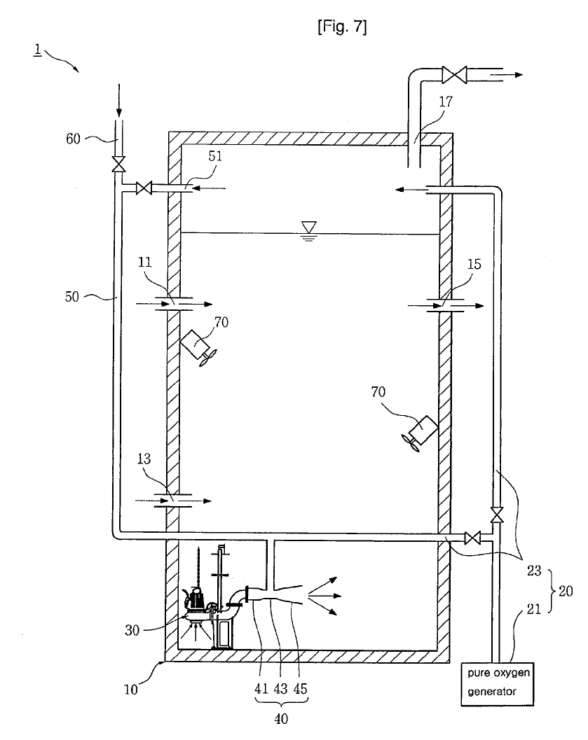

FIG. 7 is a cross-sectional view illustrating a pure oxygen aeration system for wastewater treatment according to the sixth embodiment of the present invention. As shown in FIG. 7, in the pure oxygen aeration system 1 for wastewater treatment according to the sixth embodiment of the present invention, the mixed liquor circulation device 30 is implemented as a submersible pump installed in the lower part of the aeration tank 10, and the inlet pipe 41 of the high-speed jet injection device 40 is connected to the discharge port of the submersible pump of the mixed liquor circulation device 30. Further, the throat outlet 43 of the high-speed jet injection device 40 and the expanding tube 45 are directed toward the lower part of the aeration tank 10.

Here, the structure of the high-speed jet injection device 40 can be modified to have a variety of forms, as long as the inlet pipe 41 is connected to the discharge port of the submersible pump and the throat outlet 43 is smaller than other portions of the pipe.

The oxygen suction pipe 50 and the oxygen supply pipe 23 extending to the lower part of the water in the aeration tank 10 from the pure oxygen generator 21 are connected to the throat outlet 43 of the high-speed jet injection device 40.

And, air suction pipe 60 is connected to the oxygen suction pipe 50 from outside of the aeration tank 10 and a separate oxygen supply pipe 23 is connected from the pure oxygen generator 21 to the headspace of the aeration tank 10.

In the pure oxygen aeration system 1 according to the sixth embodiment of the present invention, the mixed liquor discharged from the submersible pump, which is the mixed liquor circulation device 30, is strongly jetted toward the lower part of the aeration tank 10 through the high-speed jet injection device 40.

The headspace oxygen is sucked into the high-speed jet injection device 40 through the oxygen suction pipe 50, and the pure oxygen from the pure oxygen generator 21 is also sucked into the high-speed jet injection device 40 through the oxygen supply pipe 23, and then it is supplied to the water in the aeration tank 10 being dissolved into the mixed liquor.

For this reason, the aeration efficiency in the water of the aeration tank 10 is increased, and the efficiency of use of pure oxygen is increased.

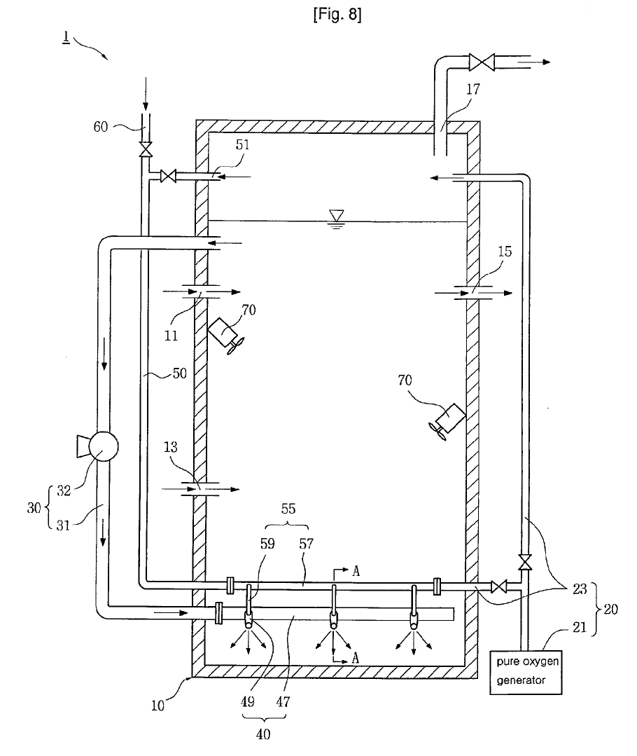

FIG. 8 is a cross-sectional view illustrating a pure oxygen aeration system for wastewater treatment according to the seventh embodiment of the present invention. As shown in FIG. 8, the structure of the pure oxygen aeration system 1 according to the seventh embodiment of the present invention is almost identical to the pure oxygen aeration system 1 according to the first embodiment, except for the structure of the high-speed jet injection device 40 and the pure oxygen supply method.

Therefore, as the explanation of the pure oxygen aeration system according to the seventh embodiment, only the high-speed jet injection device 40 and the pure oxygen supply method will be described.

The high-speed jet injection device 40 comprises a mixed liquor distribution manifold 47 and a plurality of high-speed jet nozzles 49 branching off from the mixed liquor distribution manifold 47.

The mixed liquor distribution manifold 47 is installed in the aeration tank 10 and is connected to the mixed liquor circulation pipe 31. As shown in FIG. 8, the mixed liquor distribution manifold 47 can be manufactured from a tubular pipe, or can be formed into a manifold shape having a distribution space. At this time, the mixed liquor distribution manifold 47 may be preferably installed in the lower part of the aeration tank 10 for better aeration.

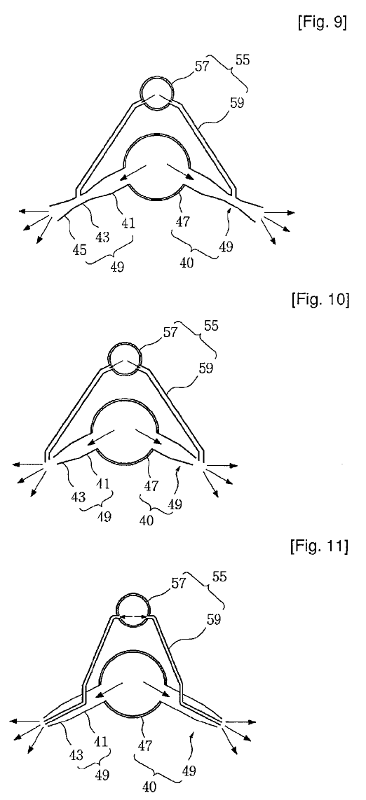

The high-speed jet nozzle 49 branches off and protrudes from a plurality of locations of the mixed liquor distribution manifold 47. As shown in FIG. 9, the high-speed jet nozzle 49 may have a structure comprising an inlet pipe 41, through which mixed liquor is introduced from the mixed liquor distribution manifold 47, an throat outlet 43 having a diameter smaller than that of the inlet pipe 41, and an expanding tube 45 extending from the throat outlet 43 and having a diameter larger than that of the throat outlet 43, in which the inlet pipe 41, the throat outlet 43 and the expanding tube 45 are integrated as a single body. Further, as shown in FIG. 10 and FIG. 11, the high-speed jet nozzle 40 may have a structure comprising an inlet pipe 41 through which mixed liquor is introduced from the mixed liquor distribution manifold 47, and a throat outlet 43 having a diameter smaller than that of the inlet pipe 41. The high-speed jet nozzle 49 may be diversely modified as long as it has the inlet pipe 41 and the throat outlet 43 having a diameter smaller than that of the inlet pipe 41.

Further, an oxygen distributor 55 is installed in the lower part of the aeration tank 10 and near the high-speed jet injection device 40, so that pure oxygen is distributed into the high-speed jet nozzles 49.

The oxygen distributor 55 has an oxygen distribution manifold 57 connected to the pure oxygen generator 21 and the oxygen suction pipe 50, and a plurality of oxygen branch pipes 59 branching off from the oxygen distribution manifold 57 and extending toward the throat outlet 43 of the high-speed jet nozzles 49.

As shown in FIG. 9, the oxygen branch pipe 59 can be directly connected to the throat outlet 43 of the high-speed jet nozzle 49, or, as shown in FIG. 10 and FIG. 11, the oxygen branch pipe 59 can be disposed near the throat outlet 43 of the high-speed jet nozzle 49. At this time, as shown in FIG. 10, the oxygen branch pipe 59 can be installed to pass through the inlet pipe 41 of the high-speed jet nozzle 49.

In the pure oxygen aeration system 1 for wastewater treatment according to the seventh embodiment of the present invention, mixed liquor circulated by the mixed liquor circulation device 30 is strongly jet injected from the mixed liquor distribution manifold 47 toward all area of the lower part of the aeration tank 10 through the high-speed jet nozzles 49. Further, pure oxygen from the oxygen suction pipe 50 and the pure oxygen generator 21 is sucked into the high-speed jet nozzles 49 through the oxygen branch pipes 59 from the oxygen distribution manifold 57, and is then supplied to the water in the aeration tank 10 and dissolved in the mixed liquor. At this time, the pure oxygen is shredded into micro bubbles by shear force of the turbulence occurring in an area close to the throat outlet 43 of the high-speed jet nozzles 49, so that it can be effectively dissolved in the mixed liquor.

For this reason, aeration is efficiently performed underwater throughout the entire space of the lower part of the aeration tank 10, and pure oxygen is effectively dissolved in the water in the aeration tank 10, so that the efficiency of use of pure oxygen is increased.

As described above, according to the present invention, the pure oxygen aeration system for wastewater treatment jet injects mixed liquor at high speed toward the lower part of the aeration tank by using the mixed liquor circulation device and the high-speed jet injection device, and thus it maximizes aeration efficiency by causing strong turbulent flow underwater in the aeration tank.

Most of the pure oxygen supplied to the aeration tank is dissolved in the water in the aeration tank by strong aeration, and pure oxygen remaining in the space above the surface of the water is reintroduced deep inside the water in the aeration tank through the high-speed jet injection device and diffusers, and so the efficiency of oxygen utilization is maximized, and cost efficiency is also increased.

Further, since treatment capacity and mixing force can be maximized by design modifications of the high-speed jet injection device and the mixed liquor circulation device, the depth of the aeration tank can be increased. For this reason, the land area for installing the aeration tank is decreased, and the installation cost can be saved.

At this time, even if the depth of the aeration tank is increased, an optimum amount of dissolved oxygen can be maintained throughout the aeration tank, regardless of the volume and depth of the aeration tank, because the efficiency of oxygen utilization is maximized by the strong mixing force.

Further, the aeration tank can be implemented as a single water basin, and harmful gas such as carbon dioxide generated in the water basin is rapidly and simply discharged outside, and so microbes can be protected from the toxicity of the harmful gas, and the lowering of pH can be prevented.

### INDUSTRIAL APPLICABILITY

As described above, according to the present invention, a pure oxygen aeration system for wastewater treatment, which has high efficiency of oxygen utilization and high cost efficiency, can reduce land requirement and facility installation costs, can maintain an optimum level of dissolved oxygen, and can rapidly and smoothly exhaust harmful gas, is provided.

1. A pure oxygen aeration system for wastewater treatment, which biologically treats wastewater using microbes of activated sludge in an aeration tank, the pure oxygen aeration system comprising:
a pure oxygen supply device including a pure oxygen generator for generating pure oxygen and at least one oxygen supply pipe extending from the pure oxygen generator to the inner part of the aeration tank;
a high-speed jet injection device installed in the aeration tank;
a mixed liquor circulation device for circulating and introducing mixed liquor of microbes of activated sludge, wastewater and oxygen into the high-speed jet injection device; and
an oxygen suction pipe for sucking in the oxygen remained in a headspace of the aeration tank and reintroducing the oxygen in the water of the aeration tank.

2. The pure oxygen aeration system according to claim 1, wherein the high-speed jet injection device comprises:
an inlet pipe through which mixed liquor from the mixed liquor circulation device is introduced, and
a throat outlet having a diameter smaller than that of the inlet pipe and being directed toward a lower part of the aeration tank.

3. The pure oxygen aeration system according to claim 2, wherein the oxygen suction pipe has an oxygen suction hole positioned in the headspace of the aeration tank and an oxygen discharge end placed in an area close to the throat outlet of the high-speed jet injection device.

4. The pure oxygen aeration system according to claim 2, wherein the high-speed jet injection device has an expanding tube extending from the throat outlet having a diameter larger than that of the throat outlet, and the oxygen discharge end of the oxygen suction pipe is connected to the throat outlet of the high-speed jet injection device.

5. The pure oxygen aeration system according to claim 4, further comprising a guide pipe having a larger diameter and surrounding concentrically the expanding tube and extending to the lower part of the aeration tank.

6. The pure oxygen aeration system according to claim 2, wherein the high-speed jet injection device includes a guide pipe having a larger diameter than that of the inlet pipe and surrounding concentrically the throat outlet, and extending to the lower part of the aeration tank, at least part of the oxygen suction pipe passes through the inlet pipe, and the oxygen discharge end is disposed near the throat outlet of the high-speed jet injection device.

7. The pure oxygen aeration system according to claim 1, wherein the high-speed jet injection device comprises,
a mixed liquor distribution manifold installed in the aeration tank for accommodating mixed liquor from the mixed liquor circulation device; and
a plurality of high-speed jet nozzles comprising inlet pipes branching off from the mixed liquor distribution manifold and throat outlets of smaller diameter with respect to the inlet pipes.

8. The pure oxygen aeration system according to claim 7, wherein a plurality of high-speed jet nozzles are integrated with expanding tubes having a diameter larger than the throat outlet and extended from each throat outlet.

9. The pure oxygen aeration system according to claim 7, further comprising an oxygen distributor having an oxygen distribution manifold installed near the mixed liquor distribution manifold and connected to at least one of the pure oxygen generator and the oxygen suction pipe and a plurality of oxygen supply pipes branching off from the oxygen distribution manifold and extending toward the throat outlet of each high-speed jet nozzle.

10. The pure oxygen aeration system according to claim 9, wherein the oxygen supply pipe passes through an internal space of the inlet pipe of the high-speed jet nozzle.

11. The pure oxygen aeration system according to claim 1, wherein the mixed liquor circulation device comprises:
a mixed liquor circulation pipe extending from an inner underwater of the aeration tank to the high-speed jet injection device; and
a circulation pump for circulating the mixed liquor from the aeration tank to the high-speed jet injection device through the mixed liquor circulation pipe.

12. The pure oxygen aeration system according to claim 1, wherein the high-speed jet injection device is installed underwater in the aeration tank and the mixed liquor circulation device is a submersible mixer which is installed underwater in the aeration tank and introduces the mixed liquor into the high-speed jet injection device.

13. The pure oxygen aeration system according to claim 1, wherein the oxygen supply pipe of the pure oxygen supply device extends to an underwater area in the lower part of the aeration tank and to the headspace of the aeration tank.

14. The pure oxygen aeration system according to claim 2, wherein the mixed liquor circulation device is a submersible pump installed in a lower part of the aeration tank and pumping out the mixed liquor into the water in the aeration tank, and the inlet pipe of the high-speed jet injection device is connected to the discharge port of the submersible pump.

15. The pure oxygen aeration system according to claim 14, wherein the oxygen supply pipe of the pure oxygen supply device is connected to the throat outlet of the high-speed jet injection device and the headspace of the aeration tank.

16. The pure oxygen aeration system according to claim 1, further comprising an atmospheric air suction pipe being connected to the oxygen suction pipe and having an air suction hole directed toward the outside of the aeration tank.

17. The pure oxygen aeration system according to claim 16, further comprising a foam separator including a foam separation tank provided outside the aeration tank, a first suction pipe connecting the headspace of the aeration tank and the foam separation tank, and a second suction pipe connecting the foam separation tank and the air suction pipe or connecting the foam separation tank and the oxygen suction pipe.

18. The pure oxygen aeration system according to claim 17, further comprising a blower installed on one side of the air suction pipe or the oxygen suction pipe so as to blow air or oxygen toward the oxygen discharge end of the oxygen suction pipe.

19. The pure oxygen aeration system according to claim 17, further comprising a blower provided outside the aeration tank, wherein the air suction pipe and the oxygen suction pipe are connected to a suction inlet of the blower, and the oxygen supply pipe is connected to the pure oxygen generator and an outlet port of the blower and extends underwater in the lower part of the aeration tank.

20. The pure oxygen aeration system according to claim 1, wherein the aeration tank has a gas exhaust device provided in an upper portion of the headspace of the aeration tank and extending toward the outside of the aeration tank.

21. The pure oxygen aeration system according to claim 1, further comprising at least on submersible mixer installed underwater in the aeration tank.
